(19) United States
(12) Patent Application Publication
(10) Pub. No.: US 2009/0119635 A1
(43) Pub. Date: May 7, 2009

(54) MASK PATTERN CORRECTION METHOD FOR MANUFACTURE OF SEMICONDUCTOR INTEGRATED CIRCUIT DEVICE

(76) Inventor: Kazuhiro Takahata, Oita-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/949,588

(22) Filed: Dec. 3, 2007

(30) Foreign Application Priority Data
Dec. 4, 2006 (JP) 2006-327239

(51) Int. Cl. G06F 17/50

(52) U.S. Cl. 716/20

(57) ABSTRACT

Mask data is generated from a design layout by executing a mask data process including optical proximity correction. A pattern is formed on the major surface of a test semiconductor substrate by using a mask prepared from the mask data. The dimensional difference between the design layout and the pattern is measured. The design layout is corrected, at a portion with the dimensional difference of the design layout, by the magnitude of the dimensional difference in a direction in which the dimensions of the pattern equal those of the design layout, thereby generating a corrected design layout. Corrected mask data is generated from the corrected design layout by executing the mask data process including the optical proximity correction. A pattern is formed on the major surface of a semiconductor substrate by using a corrected mask prepared from the corrected mask data.

### CROSS-REFERENCE TO RELATED APPLICATIONS

This application is based upon and claims the benefit of priority from prior Japanese Patent Application No. 2006-327239, filed Dec. 4, 2006, the entire contents of which are incorporated herein by reference.

### BACKGROUND OF THE INVENTION

1. Field of the Invention

The present invention relates to a mask pattern correction method for manufacture of a semiconductor integrated circuit device. The present invention also relates to a mask manufacturing method and semiconductor integrated circuit device manufacturing method using the correction method.

2. Description of the Related Art

In manufacturing a semiconductor integrated circuit device, a resist pattern is formed by lithography, an underlying film is worked by etching, and a circuit pattern is formed on a wafer. In this pattern formation technology, it is demanded to form, on a wafer, a pattern with dimensions accurately conforming to design values.

One of the techniques to do this is optical proximity correction (OPC), which corrects a deviation of the design produced, and forms a pattern with sufficient high accuracy on a wafer as a designed value. The deviation is generated by optical proximity effect (OPE) depending on the neighboring line width and the space width, or the Dense-Iso dependency of a processing conversion difference (etching bias).

Data for correcting OPE or etching bias, and accuracy of correction, i.e., each of a mask formed to acquire the dimensions of each pattern on a wafer, lithography process, etching process, correction grids of OPC model acquisition, correction convergences, and fitting residual etc, has an error of several nm, and a management value is set for each data.

However, for example, all the errors accidentally occur to make a pattern thinner than the design values, and the absolute value of the sum of errors becomes large in some cases. This poses a nonnegligible problem because if the discrepancy between the design values and the dimensions of the finally formed pattern grows, the semiconductor device cannot normally operate.

Attempts have been made so far to reduce manufacturing variations in individual processes and OPC accuracy errors. Along with the progress of the micropatterning technology, the tolerance for manufacturing errors is becoming small. Accordingly, the quota of manufacturing errors allowable in each step also becomes small, and the tolerance is approaching the working limit.

As a result, all the manufacturing margins in the individual steps narrowly satisfy the tolerance, or the manufacturing margins cancel each other between the steps and narrowly satisfy the tolerance as a whole.

In the OPC, normally, the same correction is done for the same layout. However, even when the layout does not change, generated dimensional errors change due to the manufacturing errors of a photomask or errors generated in succeeding steps. Hence, in the OPC, uncorrectable errors pose a problem, as described in. e.g., Jpn. Pat. Appln. KOKAI Publication No. 2002-148779.

### BRIEF SUMMARY OF THE INVENTION

According to a first aspect of the present invention, there is provided a mask pattern correction method comprising generating mask data from a design layout by executing a mask data process including optical proximity correction based on an optical proximity correction model, forming a pattern on a major surface of a test semiconductor substrate by using a mask prepared based on the mask data, measuring a dimensional difference between the design layout and the pattern, generating a corrected design layout by correcting the design layout, at a portion with the dimensional difference of the design layout, by a magnitude of the dimensional difference in a direction in which dimensions of the pattern equal those of the design layout, and generating corrected mask data from the corrected design layout by executing the mask data process including the optical proximity correction based on the optical proximity correction model.

According to a second aspect of the present invention, there is provided a mask manufacturing method comprising preparing a mask based on mask data which is generated from a design layout by executing a mask data process including optical proximity correction based on an optical proximity correction model, obtaining information of a dimensional difference between the design layout and a pattern formed on a major surface of a test semiconductor substrate by using the mask, and preparing a corrected mask based on corrected mask data generated by executing the mask data process including the optical proximity correction based on the optical proximity correction model on the basis of a corrected design layout generated by correcting the design layout, at a portion with the dimensional difference of the design layout, by a magnitude of the dimensional difference in a direction in which dimensions of the pattern equal those of the design layout.

According to a third aspect of the present invention, there is provided a semiconductor integrated circuit device manufacturing method comprising generating mask data from a design layout by executing a mask data process including optical proximity correction based on an optical proximity correction model, forming a pattern on a major surface of a test semiconductor substrate by using a mask prepared based on the mask data, measuring a dimensional difference between the design layout and the pattern, generating a corrected design layout by correcting the design layout, at a portion with the dimensional difference of the design layout, by a magnitude of the dimensional difference in a direction in which dimensions of the pattern equal those of the design layout, generating corrected mask data from the corrected design layout by executing the mask data process including the optical proximity correction based on the optical proximity correction model, and forming a pattern on a major surface of a semiconductor substrate by using a corrected mask prepared based on the corrected mask data.

### BRIEF DESCRIPTION OF THE SEVERAL VIEWS OF THE DRAWINGS

FIG. 1 is a flowchart for explaining a mask pattern correction method according to an embodiment of the present invention;

FIG. 2 is a schematic view of a design layout according to the embodiment of the present invention;

FIG. 3 is a view showing the designed line widths of interconnect patterns in the design layout according to the embodiment of the present invention;

FIG. 4 is a view showing the line widths of interconnect patterns formed on a test wafer;

FIG. 5 is a view showing the dimensional errors between the design layout and formed interconnect patterns, which are obtained by die-to-database inspection; and

FIG. 6 is a view showing correction values for the designed line widths of interconnect patterns in a corrected design layout according to the embodiment.

### DETAILED DESCRIPTION OF THE INVENTION

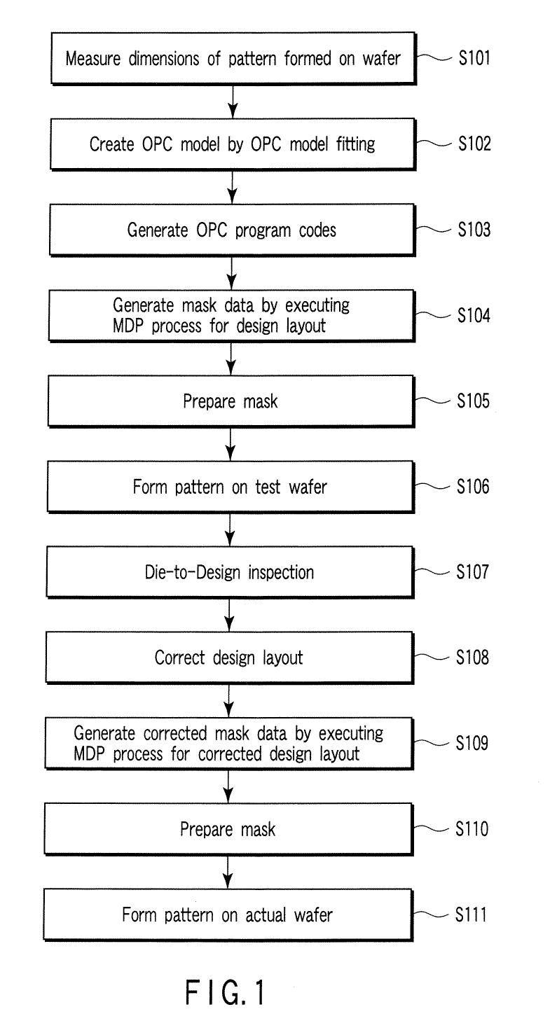

FIG. 1 is a flowchart for explaining a mask pattern correction method according to an embodiment of the present invention. FIG. 1 shows an example of a mask manufacturing method and a semiconductor integrated circuit device manufacturing method using the mask.

First, a plurality of patterns are formed on a wafer by lithography and working using a mask having a layout of a number of patterns with various dimensions, and the dimensions of the patterns are measured (step S101). This measurement corresponds to experimental data collection for creating an OPC model.

An OPC simulation model is created by executing fitting of the measured dimensions (dimensional changes) of each pattern (step S102).

Using the OPC simulation model obtained in step S102, OPC program code to execute OPC is generated (step S103).

Mask data preparation (MDP) including OPC is executed using the OPC program code obtained in step S103, thereby generating mask data from the design layout (step S104). A mask is prepared in accordance with the obtained mask data (step S105).

Interconnect patterns or insulating patterns are formed on a test wafer by the same steps as in final working on an actual wafer, i.e., lithography including exposure and development, etching, film formation, and chemical mechanical polishing (CMP) (step S106).

Thus formed patterns are affected by OPC accuracy errors, process errors in experimental data acquisition for OPC model creation, change over time, dimensional variations which depend on the coverage of a pattern with a square area having a side of several hundred μm and are uncorrectable by OPC, manufacturing errors of the photomask, and errors of the manufacturing apparatus. These factors often make the dimensions of the formed patterns deviate from the design values of design layout.

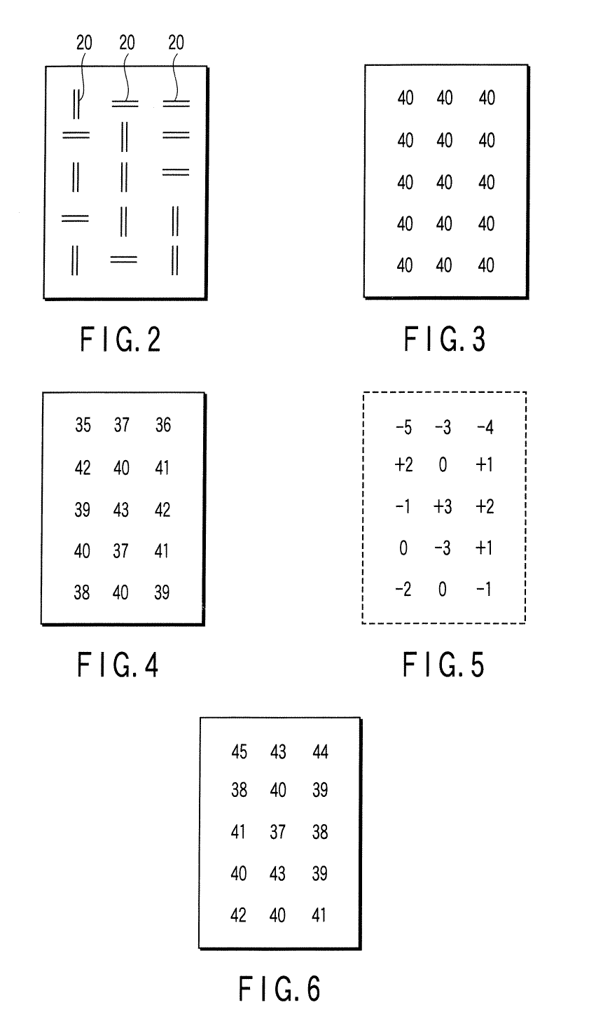

For example, assume that interconnect patterns 20 are distributed as in the design layout shown in the schematic of FIG. 2, and all the patterns have a designed line width (dimension) of 40 nm, as shown in FIG. 3. Each numerical value (unit: nm) in FIG. 3 indicates the designed line width of the interconnect pattern 20 located at a corresponding position in FIG. 2.

Interconnect patterns are actually formed on a test wafer in accordance with the design layout shown in FIG. 2 by the processes in steps S101 to S106. The line widths of the formed interconnect patterns deviate from the design value and vary, as shown in FIG. 4. Each numerical value (unit: nm) in FIG. 4 indicates the line width of the interconnect pattern formed at a corresponding position in FIG. 3.

Die-to-design inspection is executed by superimposing the design layout on the two-dimensional shapes of the patterns formed on the test wafer in step S106 and measuring dimensional differences generated by errors (step S107). In this case, regarding all patterns in the pattern layout throughout the chip, dimensional errors generated by all factors such as the OPC accuracy errors and processes (lithography, etching, . . . ) are measured.

In the examples shown in FIGS. 3 and 4, information in FIG. 5, which represents the dimensional differences between FIGS. 3 and 4, is obtained by the die-to-database (or die-to-design) inspection. Each numerical value (unit: nm) in FIG. 5 indicates the deviation between the designed line width and the line width of the interconnect pattern formed at a corresponding position in FIG. 3.

The design layout is corrected, at a portion with a dimensional difference on it, by the magnitude (absolute value) of the dimensional difference in a direction in which the dimensions of the formed pattern equal those of the design layout, thereby generating a corrected design layout (step S108). That is, the design layout throughout the chip can be corrected by using the dimensional errors of all patterns throughout the chip acquired in step S107.

When a corrected design layout is generated on the basis of the design layout shown in FIG. 2, the correction value of the designed line width of each interconnect pattern 20 is obtained as a corresponding value (unit: nm) in FIG. 6, i.e., a value obtained by inverting the sign of the dimensional error at a corresponding position in FIG. 5 and adding the resultant value to the designed line width in FIG. 3.

For example, the interconnect pattern on the first row, second column in FIG. 3 has a design value of 40 nm. If this pattern is formed with a line width of 37 nm on the test wafer, as shown in FIG. 4, the dimensional error is −3 nm, as shown in FIG. 5. Hence, the design layout is corrected by changing the designed line width to 40+3=43 nm, as shown in FIG. 6.

The same mask data process as in step S104 is executed for the corrected design layout obtained in step S108, thereby generating corrected mask data (step S109). Hence, in the OPC process executed here, the OPC simulation model obtained in step S102 is used without correction. Note that the above processes in steps S101 to S109 may be executed by a single semiconductor mask data generating apparatus having means for implementing the respective processes.

A mask is prepared in accordance with the corrected mask data obtained in step S109 (step S110). Patterns are formed on an actual wafer by lithography including exposure and development, etching, film formation, and CMP.

The patterns on the actual wafer are formed on the basis of the design layout which is corrected to cancel the dimensional errors of the patterns formed on the test wafer. Hence, the patterns have a high accuracy close to the initial design value layout even when the initial dimensional errors are generated by a combination of various factors such as the OPC accuracy error and manufacturing errors. In the example shown in FIG. 2, the interconnect patterns 20 having dimensional values close to the numerical value in FIG. 3 can be formed.

As described above, in the mask pattern correction method according to this embodiment, an inspection apparatus reads dimensional errors between the design value and patterns formed on a test wafer. A design pattern capable of canceling the errors is formed, and a mask is prepared again on the basis of the design pattern. This makes it possible to simultaneously reduce, by only one correction operation, the dimensional errors from the design layout based on various factors such as the OPC accuracy error and errors which are generated by, e.g., process variations and are uncorrectable by OPC. As a result, patterns close to the design layout can accurately be formed on a wafer.

It is possible to manufacture a photomask by using the mask pattern correction method of this embodiment or a semiconductor mask data generating apparatus incorporating the correction method. When a semiconductor integrated circuit device is manufactured by executing lithography using the thus prepared mask and executing processes such as etching and film formation, patterns close to the dimensions initially designed by the designer can be formed accurately. This suppresses characteristic variations caused by dimensional variations and improves the manufacturing yield of semiconductor integrated circuit devices.

As described above, a mask pattern correction method according to a first embodiment of the present invention comprises steps of generating mask data from a design layout by executing a mask data process including optical proximity correction based on an optical proximity correction model, forming a pattern on a major surface of a test semiconductor substrate by using a mask prepared based on the mask data, measuring a dimensional difference between the design layout and the pattern, generating a corrected design layout by correcting the design layout, at a portion with the dimensional difference of the design layout, by a magnitude of the dimensional difference in a direction in which dimensions of the pattern equal those of the design layout, and generating corrected mask data from the corrected design layout by executing the mask data process including the optical proximity correction based on the optical proximity correction model.

A design layout correction method according to a second embodiment of the present invention comprises steps of generating mask data from a design layout, forming a pattern on the major surface of a test semiconductor substrate by using a mask prepared based on the mask data, measuring the dimensional difference between the design layout and the pattern, and generating a corrected design layout by correcting the design layout, at a portion with the dimensional difference of the design layout, by the magnitude of the dimensional difference in a direction in which the dimensions of the pattern equal those of the design layout.

A mask manufacturing method according to a embodiment aspect of the present invention comprises steps of preparing a mask based on mask data which is generated from a design layout by executing a mask data process including optical proximity correction based on an optical proximity correction model, obtaining information of a dimensional difference between the design layout and a pattern formed on a major surface of a test semiconductor substrate by using the mask, and preparing a corrected mask based on corrected mask data generated by executing the mask data process including the optical proximity correction based on the optical proximity correction model on the basis of a corrected design layout generated by correcting the design layout, at a portion with the dimensional difference of the design layout, by a magnitude of the dimensional difference in a direction in which dimensions of the pattern equal those of the design layout.

A semiconductor integrated circuit device manufacturing method according to a fourth aspect of the present invention comprises steps of generating mask data from a design layout by executing a mask data process including optical proximity correction based on an optical proximity correction model, forming a pattern on a major surface of a test semiconductor substrate by using a mask prepared based on the mask data, measuring a dimensional difference between the design layout and the pattern, generating a corrected design layout by correcting the design layout, at a portion with the dimensional difference of the design layout, by a magnitude of the dimensional difference in a direction in which dimensions of the pattern equal those of the design layout, generating corrected mask data from the corrected design layout by executing the mask data process including the optical proximity correction based on the optical proximity correction model, and forming a pattern on a major surface of a semiconductor substrate by using a corrected mask prepared based on the corrected mask data.

A semiconductor mask data generating apparatus according to a fifth embodiment of the present invention comprises means for generating mask data from a design layout, means for obtaining information of the dimensional difference between the design layout and a pattern formed on the major surface of a test semiconductor substrate by using a mask prepared based on the mask data, and means for generating semiconductor mask data from a corrected design layout generated by correcting the design layout, at a portion with the dimensional difference of the design layout, by the magnitude of the dimensional difference in a direction in which the dimensions of the pattern equal those of the design layout.

As described above, according to one aspect of this invention, it is possible to provide a semiconductor integrated circuit device manufacturing method, mask manufacturing method, semiconductor mask data generating apparatus, mask pattern correction method, and design layout correction method capable of improving the yield by accurately forming design layout patterns on a wafer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mask pattern correction method comprising:
generating mask data from a design layout by executing a mask data process including optical proximity correction based on an optical proximity correction model;
forming a pattern on a major surface of a test semiconductor substrate by using a mask prepared based on the mask data;
measuring a dimensional difference between the design layout and the pattern;
generating a corrected design layout by correcting the design layout, at a portion with the dimensional difference of the design layout, by a magnitude of the dimensional difference in a direction in which dimensions of the pattern equal those of the design layout; and
generating corrected mask data from the corrected design layout by executing the mask data process including the optical proximity correction based on the optical proximity correction model.

2. A method according to claim 1, wherein generating the mask data comprises:
measuring pattern dimensions of a plurality of patterns formed on the wafer;
creating an optical proximity correction simulation model based on a measurement result;
generating optical proximity correction program code to execute optical proximity correction by using the obtained optical proximity correction simulation model; and
generating the mask data from the design layout by using the obtained optical proximity correction program code.

3. A method according to claim 2, wherein in creating the optical proximity correction simulation model, the optical proximity correction simulation model is created by executing fitting for a measured dimensional change of each pattern using the model.

4. A method according to claim 2, wherein generating the mask data from the design layout is done by executing the mask data process including the optical proximity correction.

5. A method according to claim 4, wherein measuring the dimensional difference comprises executing die-to-database inspection.

6. A method according to claim 5, wherein in the die-to-database inspection, dimensional errors of all patterns throughout the pattern layout, which are generated by an accuracy error of optical proximity correction and a process, are measured.

7. A method according to claim 1, wherein in generating corrected mask data, the corrected mask data is generated by executing, for the obtained corrected design layout, substantially the same mask data process as that executed in generating the mask data.

8. A mask manufacturing method comprising:
preparing a mask based on mask data which is generated from a design layout by executing a mask data process including optical proximity correction based on an optical proximity correction model;
obtaining information of a dimensional difference between the design layout and a pattern formed on a major surface of a test semiconductor substrate by using the mask; and
preparing a corrected mask based on corrected mask data generated by executing the mask data process including the optical proximity correction based on the optical proximity correction model on the basis of a corrected design layout generated by correcting the design layout, at a portion with the dimensional difference of the design layout, by a magnitude of the dimensional difference in a direction in which dimensions of the pattern equal those of the design layout.

9. A method according to claim 8, wherein preparing the mask comprises:
measuring pattern dimensions of a plurality of patterns formed on the wafer;
creating an optical proximity correction simulation model based on a measurement result;
generating optical proximity correction program code to execute optical proximity correction by using the obtained optical proximity correction simulation model;
generating the mask data from the design layout by using the obtained optical proximity correction program code; and
preparing the mask in accordance with the obtained mask data.

10. A method according to claim 9, wherein in creating the optical proximity correction simulation model, the optical proximity correction simulation model is created by executing fitting for a measured dimensional change of each pattern using the model.

11. A method according to claim 9, wherein generating the mask data from the design layout is done by executing the mask data process including the optical proximity correction.

12. A method according to claim 11, wherein obtaining the information of the dimensional difference comprises executing die-to-database inspection.

13. A method according to claim 12, wherein in the die-to-database inspection, dimensional errors of all patterns throughout the pattern layout, which are generated by an accuracy error of optical proximity correction and a process, are measured.

14. A semiconductor integrated circuit device manufacturing method comprising:
generating mask data from a design layout by executing a mask data process including optical proximity correction based on an optical proximity correction model;
forming a pattern on a major surface of a test semiconductor substrate by using a mask prepared based on the mask data;
measuring a dimensional difference between the design layout and the pattern;
generating a corrected design layout by correcting the design layout, at a portion with the dimensional difference of the design layout, by a magnitude of the dimensional difference in a direction in which dimensions of the pattern equal those of the design layout;
generating corrected mask data from the corrected design layout by executing the mask data process including the optical proximity correction based on the optical proximity correction model; and
forming a pattern on a major surface of a semiconductor substrate by using a corrected mask prepared based on the corrected mask data.

15. A method according to claim 14, wherein generating the mask data comprises:
measuring pattern dimensions of a plurality of patterns formed on the wafer;
creating an optical proximity correction simulation model based on a measurement result;
generating optical proximity correction program code to execute optical proximity correction by using the obtained optical proximity correction simulation model; and
generating the mask data from the design layout by using the obtained optical proximity correction program code.

16. A method according to claim 15, wherein in creating the optical proximity correction simulation model, the optical proximity correction simulation model is created by executing fitting for a measured dimensional change of each pattern using the model.

17. A method according to claim 15, wherein generating the mask data from the design layout is done by executing the mask data process including the optical proximity correction.

18. A method according to claim 17, wherein measuring the dimensional difference comprises executing die-to-database inspection.

19. A method according to claim 18, wherein in the die-to-database inspection, dimensional errors of all patterns throughout the pattern layout, which are generated by an accuracy error of optical proximity correction and a process, are measured.

20. A method according to claim 14, wherein in generating corrected mask data, the corrected mask data is generated by executing, for the obtained corrected design layout, substantially the same mask data process as that executed in generating the mask data.
